(19) United States
(12) Patent Application Publication
(10) Pub. No.: US 2008/0160488 A1
(43) Pub. Date: Jul. 3, 2008

(54) TRAINEE-AS-MENTOR EDUCATION AND TRAINING SYSTEM AND METHOD

(75) Inventors: William Younkes, Greenwood Village, CO (US); Dave E. Wilson, Castle Rock, CO (US)

Correspondence Address: SWANSON & BRATSCHUN, L.L.C., 8210 SOUTHPARK TERRACE, LITTLETON, CO, 80120, US

(73) Assignee: MEDICAL SIMULATION CORPORATION, Denver, CO (US)

(21) Appl. No.: 11/617,049

(22) Filed: Dec. 28, 2006

(51) Int. Cl. G09B 19/00

(52) U.S. Cl. 434/219

(57) ABSTRACT

An education and training system and method where a trainee plays the role of a mentor to a simulated colleague who is performing a simulated procedure. Various views of the simulated colleague are presented on one or more monitors so that the trainee-as-mentor can observe the actions taken by the simulated colleague. The views will often be focused upon the hands of the simulated colleague. The trainee-as-mentor must observe the simulated colleague and provide instructions or commands to the simulated colleague in order to correct inappropriate actions. The trainee-as-mentor is evaluated on his or her ability to discern mistakes, miscues, poor technique, out of order steps, etc., and provide instructions to correct the mistake and prevent undesired outcomes.

### FIELD OF THE INVENTION

This invention relates to the field of education and training, and more particularly, to an enhanced method and system for educating and training where the person being trained plays the role of a mentor to a simulated colleague who is performing a simulated task or procedure.

### BACKGROUND OF THE INVENTION

Robust, interactive online simulations often put learners in a virtual environment, encourage them to collaborate, and force them to make decisions. Participants, immersed in an experience that draws on their individual expertise and teamwork skills, learn by doing. Proponents of the technology suggest that interactive computerized simulations are one of the most effective ways to learn and ultimately master a wide range of tasks and skills.

Some experts credit simulations with accelerating the learning curve. According to one expert, students learning via simulation-based training become proficient more quickly. When students learn on the job, it may take them longer to be able to perform the same task with the same proficiency. Proponents also point out that simulations allow trainees to practice newly acquired skills and apply new knowledge in a realistic, yet risk-free environment. This means, for example, that trainees feel they can experiment and explore the cause-and-effect relationships between decisions and outcomes without facing real-world consequences such as crashing a plane, killing a patient, ruining a piece of work, etc.

The experience provided by a quality simulation simply cannot be matched by traditional learning or a lecture-based course. Other types of learning do not emphasize skills acquired when people work together and influence each other. Simulations present a methodology that promotes people beyond their academic understanding of a subject. Students can learn what happens to them under stress when they are challenged or exposed to change or ambiguity.

In the medical field, for example, healthcare education leaders have expressed a need for simulation systems that efficiently train, evaluate, and enhance individual medical practitioner's skills to improve patient outcomes. In a recent survey, 73 of the 124 US medical schools were using some form of computer simulation for student evaluation. The development of simulation and training centers for the cognitive training of healthcare professionals in the practice of interventional medical procedures represents a significant advance toward the promotion of the best demonstrated practices in the use of existing and new products and procedures. The introduction rate of new therapeutic devices and procedures is accelerating such that the lifecycle of a new product can be as short as eighteen months. At the same time the American College of Cardiology reports that 50% of the 10,000 interventional cardiologists do not meet the minimum standards for procedure competency. There is thus a continuing need in the art for cognitive training and education methods that enhance the effectiveness of simulation training.

The present invention is directed toward overcoming one or more of the problems discussed above.

### SUMMARY OF THE INVENTION

The present invention is a training method, system, and software program delivered on a computer-readable medium which includes simulation training where the trainee fills the role as a mentor to a simulated colleague performing a simulated procedure. Although the invention is described in terms of a disclosed method in this summary, the method may be implemented as part of a system or delivered as a program on computer-readable medium. These alternative embodiments of the invention are within the scope of the present invention.

One aspect of the present invention includes providing a simulation system for simulating a desired procedure. Typically, the procedure will include one or more actions. The actions will be performed by a simulated colleague. The invention also includes displaying to the trainee-as-mentor the simulated colleague performing the simulated procedures and accepting input to the simulation system from the trainee-as-mentor in response to the performance of the simulated procedure by the simulated colleague.

The trainee experience may be enhanced by having the simulated colleague erroneously perform one or more actions associated with the procedure. Input from the trainee-as-mentor at or near the time of the erroneous performance of the procedure may be analyzed to determine whether or not the trainee-as-mentor recognized the error and whether any input from the trainee-as-mentor is appropriate to mitigate a possible effect of the error. Subsequent actions performed by the simulated colleague may be selected from any number of multiple possible subsequent actions based upon the trainee-as-mentor's input or non-input received after the simulation of an error.

In particular, an undesirable occurrence may be simulated upon determination that the trainee-as-mentor did not provide appropriate input to mitigate a possible effect of the error. The undesirable occurrence may be the performance of a subsequent compounding error of the simulated colleague. Alternatively, the undesirable occurrence may be the failure of the simulated colleague to successfully complete the simulated procedure. Other types of undesirable occurrences will be readily apparent to those skilled in the art when considering the development of a simulation to teach a select procedure. The simulation may alternatively be programmed to simulate a desirable occurrence upon the determination that the trainee-as-mentor provided appropriate input to mitigate possible effects of the simulated error.

The simulation system and method described herein may include additional steps which enhance the experience of working with the simulation system. For example, provision may be made for pausing the simulated procedure upon receipt of input from the trainee-as-mentor and providing feedback regarding the error or the response to the error. The input to the simulation system from the trainee-as-mentor may be delivered through any device, including but not limited to, a keyboard, keypad, computer mouse, touch screen, microphone, joystick, a mechanical device in communication with the simulation system, a writing tool, or a simulated tool or detector associated with the trainee-as-mentor which may be specifically tailored for use with the simulated procedure. The simulated procedure may be displayed to the trainee-as-mentor as an image, an audible sound, a tactile feedback text or other type of display. The display may be formatted for the projection of multiple selectable points of view. In addition, the system may be configured to generate a report upon the completion of the simulated procedure containing commentary upon the errors made by the simulated colleague and the trainee-as-mentor's responses thereto.

### BRIEF DESCRIPTION OF THE DRAWINGS

FIG. 1 shows a schematic/block diagram of an embodiment of a computer system suitable for the implementation of the education and training system and method of the present invention.

FIG. 2 shows a representative display consistent with the present invention.

FIG. 3 shows a flowchart representation of a method consistent with the present invention.

FIG. 4 shows a perspective view of a portable medical simulation system suitable for the implementation of the education and training system and method of the present invention.

### DETAILED DESCRIPTION OF THE INVENTION

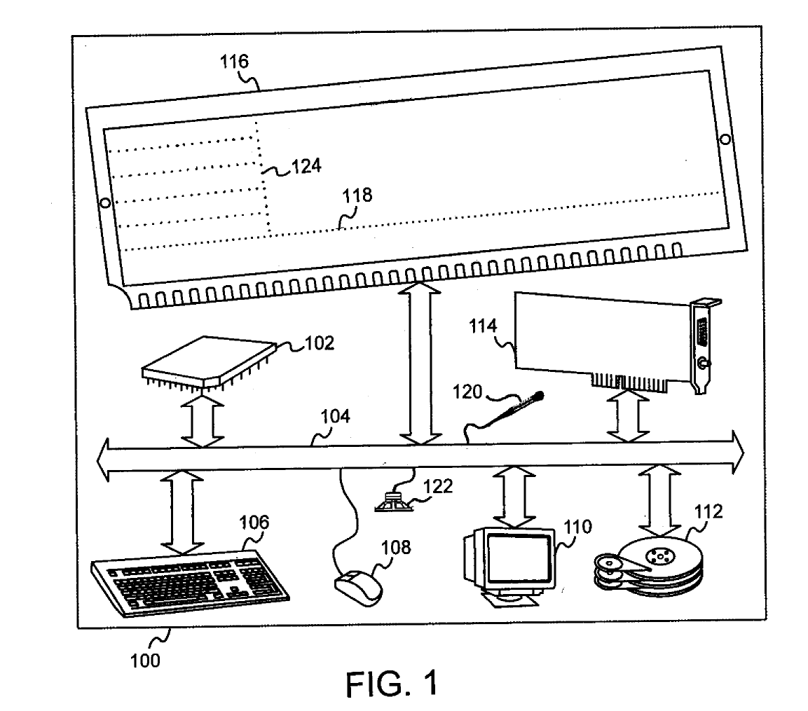

Referring now to the Figures, in which like reference numerals and names refer to structurally and/or functionally similar elements thereof, FIG. 1 shows a schematic/block diagram of an embodiment of a computer system incorporating the education and training system and method of the present invention. The present invention may function on a mainframe computer system, a stand alone personal computer system, or a networked distributed computer system. The computer system shown in FIG. 1 is an exemplary embodiment and the invention is not limited to the embodiment shown.

Referring now to FIG. 1, a Computer System 100 contains a Processing Element 102. The Processing Element 102 which may communicate to other elements of the Computer System 100 over a System Bus 104. A Keyboard 106 or other input device allows a user to input information into Computer System 100, and a Graphics Display 110 or other output device allows Computer System 100 to output information to the user. More than one Graphics Display 110 may be utilized with Computer System 100, and each Graphics Display 110 may have the output information shown with a split-screen effect. Graphics Display 110 may also be touch-screen enabled, allowing a user to input information into Computer System 100 through this mode. Graphical Input Device 108, which may be a mouse, joy stick, simulated tool or other type of pointing device, is also used to input information. A Storage Device 112 is used to store data and programs within Computer System 100. A Memory 116, also connected to System Bus 104, contains an Operating System 118, and the Training Software 124 of the present invention. A Communications Interface 114 is also connected to System Bus 104. Communications Interface 114 may have one or more serial ports, parallel ports, infrared ports, and the like. Connectable through Communications Interface 114 may be an external printer or scanner, as well as access to a computer network (LAN or WAN), to the Internet, or to any other appropriate communication channel (not shown in FIG. 1). A Microphone 120 for capturing speech for input and a Speaker 122 four outputting audible information are also connected to System Bus 204. Microphone 120 may be integral to or externally connected to Computer System 100.

Images consistent with the methods described herein may be delivered by a computer system, such as Computer System 100 contained in a software program, such as Training Software 124, and displayed on a display device, such as Graphics Display 110. The images or other output may be of the education and training system and method of the present invention. In one example of a training exercise described in detail below, the trainee-as-mentor will be watching a simulated colleague repair a jet-boat engine. The images displayed on Graphics Display 110 may be a series of still photographs, or may be streaming film or video. There may be audio output through Speaker 122 that accompanies the still photos or streaming film or video. Or, there may be no audio output at all. The trainee-as-mentor may have input into the training exercise through audio input via Microphone 120 working in conjunction with voice recognition software incorporated into Training Software 124. Or, input may be received through touch-screen input from the trainee-as-mentor through a split-screen with the images, or through a second graphics display unit that allows for touch-screen input. Alternatively, input may be received from the trainee-as-mentor through utilization of Graphical Input Device 108 and/or Keyboard 106 in conjunction with Graphics Display 110. Input may be through a tool in electronic communication with the computer system 100, which tool may be a simulated tool or smart tool as described herein. All of these types of input may be incorporated into the training exercise. One skilled in the art will recognize that depending upon the objective of the training scenario and the complexity of the training, various combinations of inputs and outputs may be utilized.

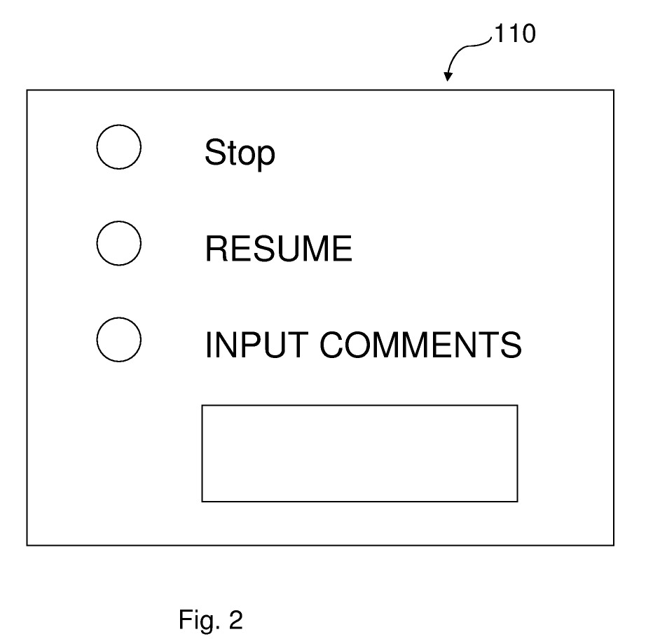

FIG. 2 shows a screen shot displayed on Graphics Display 110 of one possible input where the trainee-as-mentor may utilize Graphical Input Device 108 to click within the radio buttons displayed to “Stop” the training scenario, “Resume” the training scenario, or “Input Comments” through entering text into the dialog box with Keyboard 106 as is typical with an operating system such as Windows™. In addition, Graphics Display 110 may be touch-screen enabled allowing the trainee-as-mentor to touch the screen to “Stop,” “Resume,” and “Input Comments.” FIG. 2 may be displayed split-screen on Graphics Display 110 or on a second graphics display.

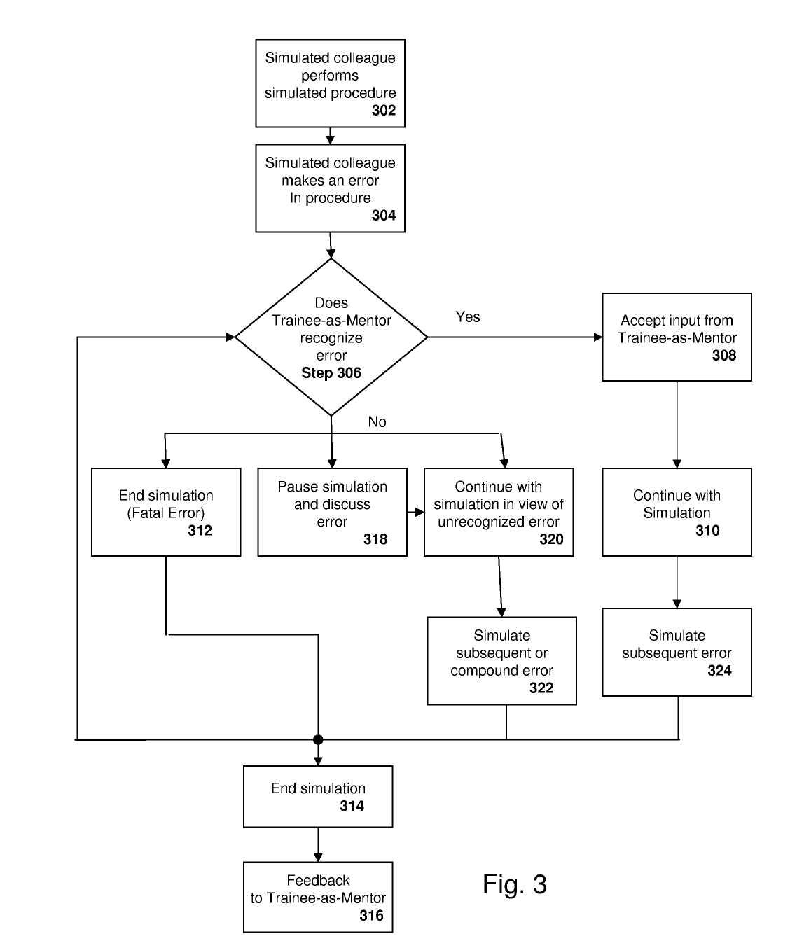

FIG. 3 illustrates in flowchart form a generalized embodiment of one method disclosed herein. Those skilled in the art will recognize that the steps detailed on FIG. 3 may be varied, in particular the order of steps may be changed or supplemental steps may be added within the scope of the method disclosed herein. In all embodiments of the present training method, the trainee fills the role of “trainee-as-mentor”. Thus, the trainee learns by teaching a colleague desired skills. As described in detail below, the colleague is a simulated colleague who is programmed to perform a procedure which is presented to the trainee-as-mentor through the various interfaces described above.

The method as described herein may begin with a simulated colleague performing a simulated procedure (step 302). Typically, the procedure performed by the simulated colleague in step 302 will include a series of related actions which would be performed during a procedure which is the subject of the simulation. The actions which are components of the procedure are displayed to the trainee-as-mentor through audio and visual apparatus as described above.

At some point in the simulated procedure, the simulated colleague may make an error or otherwise incorrectly perform an aspect of the procedure (step 304). The error made by the simulated colleague may be simple and straightforward, or subtle. As used herein, the word “error” is defined as any variation from a predefined correct procedure. An error is an incorrect or undesirable action which would illicit input from an actual mentor. In the case of the present method, an error might include the simulated colleague incorrectly performing a task, or the simulated colleague correctly performing a task but out of the order dictated by a most preferred order of operation. The nature of simulated events which occur after the error will preferably be affected by the trainee-as-mentor's recognition and response to the error (step 306). It should be noted that the trainee-as-mentor may fail to recognize the error. Alternatively, the trainee-as-mentor may recognize the error. In the event the trainee-as-mentor does recognize the error, he or she may selectively pause the simulation and provide input to the simulation concerning corrective action or a preferred course with respect to the error (step 308). Upon receipt of corrective input, a simulated correction may be made and the simulation may continue (step 310).

Several alternative simulation paths may be available, if the trainee-as-mentor does not recognize the error. For example, the simulated error may be of such magnitude that the simulated procedure cannot be completed in view of the unrecognized error (step 312). In such instance, the simulation may end (step 314) and feedback may be provided to the trainee-as-mentor as described above (step 316). Alternatively, the simulation may be programmed to pause after a select time period or after it becomes clear that the trainee-as-mentor did not recognize an error so that the nature of the error and the desired corrective action may be conveyed to the trainee-as-mentor (step 318). In many instances, it may be desirable to simply continue with the simulation, with the course of the simulation modified, however, in view of the unrecognized error (step 320). After the simulation has resumed, it may be a useful teaching opportunity to simulate subsequent or compound errors which either arise or are exacerbated by the unrecognized initial error (step 322). Thus, the present method accurately simulates the real-life experience of one error which is not corrected leading to subsequent (possibly fatal) errors.

Assuming that the initial error of step 304 was recognized by the trainee-as-mentor and suitable corrective input was made in step 308, the simulation may include the simulation of subsequent unrelated errors (step 324). For each subsequent error (steps 322, 324), the future course of the simulation may be affected as described above based upon the trainee-as-mentor's recognition or failure to recognize or correct the error (step 306). For each subsequent error, the simulation may end, pause for discussion or continue depending on the nature of the programming. Those skilled in the art will recognize that an unlimited number of permutations involving errors recognized or not, corrective actions, subsequent errors and fatal errors may be devised and programmed depending upon the requirements of the field of the training simulation.

In every case, the simulation will ultimately end (step 314), whereupon feedback may be provided to the trainee-as-mentor concerning his or her performance guiding the simulated colleague through the procedure.

Specific examples of the method generally described above are included below. It will be readily apparent to those skilled in the art, however, that the trainee-as-mentor system and method as described herein is applicable to a training simulation prepared for any field or procedure. Therefore, the examples described in detail below are provided to further illustrate the general concepts which are described above. The subject matter and procedures described in the specific examples are not limiting upon the scope of this invention in any way.

One representative training scenario begins with audio output over Speaker 124, or visual display on Graphics Display 110, or a combination of both, where a narrator indicates that when a jet boat engine was disassembled, and certain damage was assessed, it was determined that the engine was severely damaged. The engine can be rebuilt, but will require significant parts replacement, including cylinder head, block, piston and rod. Still, rebuilding the engine, rather than purchasing an entire new one, will result in savings of several hundred dollars. This project has been given a difficulty rating of five out of a possible five on a difficulty-rating scale. The narrator goes on to state that the steps in this engine repair procedure are applicable to most similar engines. However, with any particular engine, there may be procedures, specifications, settings, tolerances, components, etc. that are specific to that engine. There are also variations according to the type and brand of repair components selected. The narrator states that one should always wear eye protection, and follow proper safety precautions, when working with power tools. As a standard safety precaution, always disconnect the engine's negative battery cable before beginning work on any electrical or mechanical components.

The narrator states that new engine parts were purchased, but first the old engine was assessed for salvageable parts. A number of parts such as the impeller coupler, the flywheel, the starter, and other components were saved from the original engine.

At this point in the simulation, the trainee-as-mentor observes that the simulated colleague has flipped the new engine block over and is removing the bolts from the block. The trainee-as-mentor observes that the simulated colleague has removed the bottom portion of the block and is inspecting the block interior and bearing surfaces and seal grooves. In the block portion, the simulated colleague identifies the holes where pins are installed to hold the bearings in place. The narrator states that these new-block halves usually have very sharp edges and urges caution when handling them.

The trainee-as-mentor subsequently observes the simulated colleague inspecting the new crankshaft. On this crankshaft, the connecting rods come already connected to the shaft, unlike an automotive crankshaft in which the rods are installed separately. The simulated colleague points to the roller bearings on this crankshaft. The simulated colleague then returns the crankshaft to its packaging to protect it and keep it clean until it is time to install it.

Before installing the crankshaft into the block, the seals need to be installed onto the crankshaft. The simulated colleague holds the seal which has raised ridges on the surface. The ridges indicate which side is oriented to the outside. The simulated colleague carefully lowers the seal onto the end of the crankshaft, making sure not to damage the seal or the crank. However, the display viewed by the trainee-as-mentor shows the simulated colleague putting the seal on wrong side out. This is the first mistake that the simulated colleague has made.

At this point, if the trainee-as-mentor has observed this mistake, he may use Graphical Input Device 108 to click within the radio button displayed to “Stop” the training scenario, and in the text box, utilizing Keyboard 106, type in a description of the mistake made by the simulated colleague. With a speech recognition enabled training system, the trainee-as-mentor may simply say “Stop” to halt the training scenario, and then verbally describe the mistake made. The speech recognition software component of the system may evaluate speech input, and if it is understood, may output a verbal response through Speaker 122. If not understood, the training software outputs a repeat command. Other input methods are described above. Once any method of input/output has been employed, the trainee-as-mentor may then click on the “Resume” radio button to continue the training scenario, or speak the word “Resume.” In more sophisticated training scenarios, the previous scene may be replayed, but with the simulated colleague performing the procedure correctly. Otherwise, the training scenario continues with the next scene.

If the error is not detected by the trainee-as-mentor, multiple alternatives are available to the programmer of the training procedure. In certain training scenarios, it may be desired to have no adverse consequences occur which have an affect on the rest of the training scenario. In other training scenarios, the failure to detect the error will cause subsequent problems or adverse consequences as the training scenario progresses. At some point, the first undetected error, or the accumulation of additional undetected errors, may prevent the training scenario from being completed. In this instance, the training software may be programmed to launch a review of the trainee-as-mentor's performance, indicating where mistakes were correctly observed, and those mistakes that were not caught. The training software may also generate a report of the trainee-as-mentor's performance for display on Graphics Display 110, or send the report to an attached or networked printer to provide the trainee-as-mentor a paper copy of his performance.

In the jet boat engine example, the scenario may continue even though the first mistake by the simulated colleague was not corrected. For example, the opposite end of this crankshaft utilizes a double-seal. This is clearly shown in the simulation. One of the pair of seals, held in the simulated colleague's left hand, has raised portions on one side, indicating the side that should be oriented toward the outside. The simulated colleague then installs the inner ring and the outer ring seals. This is the second mistake in the training scenario, as the simulated colleague has not oriented the two rings properly, and has installed them incorrectly. At this point, if the trainee-as-mentor has observed this mistake, he may stop the trainings scenario as described above, and enter in a description of the mistake. If the trainee fails to detect this mistake, the training software will note the missed observation, and the scenario will continue if the mistake does not prevent the following steps from being executed. In some scenarios, the failure to catch a mistake may be fatal to the continuation of the training scenario. In such case, a review of the trainee-as-mentor's performance may be presented, as described above.

With the seals installed, the simulated colleague is next shown to carefully lower the crankshaft into position in the block. The simulated colleague begins to apply sealant to the mating surface of the lower half of the block. The simulated colleague needs to make sure to get complete coverage, and in one section, fails to do so, which is the next mistake in this training scenario. If the trainee-as-mentor has observed this mistake, he may stop the training scenario and enter in a description of the mistake. If not, the training software will note the missed observation, and the scenario will continue if possible. If continuation is not possible, then the training session ends and a report may be generated or other feedback given to the trainee-as-mentor.

The jet boat engine repair simulation may continue similarly for as long as is desired or necessary to teach the desired procedure. The simulated colleague may continue to make mistakes or errors which may be corrected by the trainee-as-mentor if they are noticed. Subsequent simulated steps will preferably be selected and presented by the system based upon the input or lack thereof received from the trainee-as-mentor. Ultimately, the training scenario ends. At this point, a review of the trainee-as-mentor's performance may be presented, as described above. Additionally, the training software may allow the trainee-as-mentor to review the portions of the training scenario where mistakes were missed.

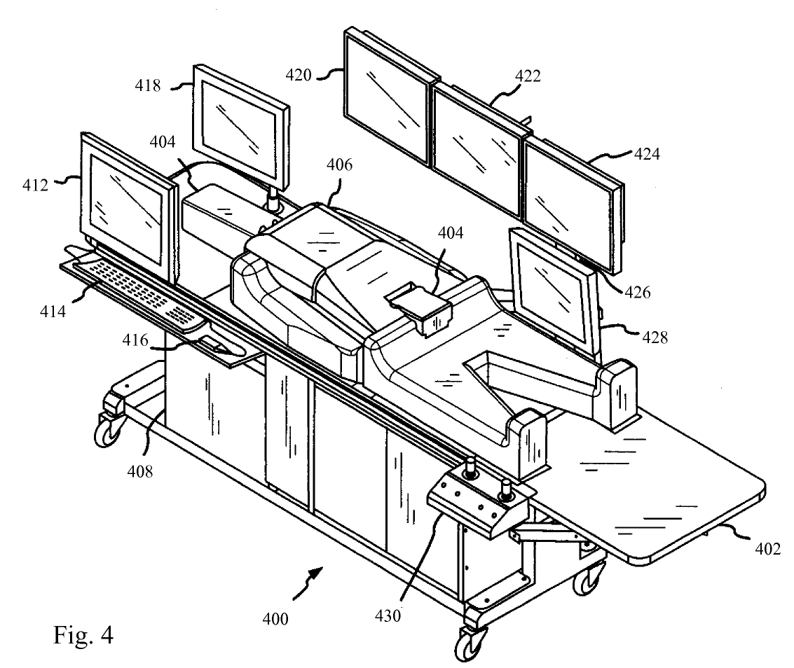

FIG. 4 illustrates another system for the implementation of the trainee-as-mentor method of the present invention, Simulation System 400. Simulation System 400 provides an industry platform, a standard for technical parameters, skill assessment and measurement, and communications capability. Simulation System 400 is described in detail in pending patent application Ser. No. 11/107,025 titled “Medical Simulation System And Method”, which is commonly owned by the assignee of the present invention, and which is incorporated herein by reference in its entirety.

Simulation System 400 provides attributes of a simulated patient's anatomy, disease state, and the decisions and selections of the trainee-as-mentor interact in both a deliberate and random manor, as in a real patient, to produce unpredictable outcomes. Even though the trainee-as-mentor may properly instruct and correct the simulated colleague who is performing a simulated medical procedure, other complications as a result of or related to the procedure, anatomy, disease state, medical device, or drug agent could result in an adverse event and a negative outcome. Conversely, if the trainee-as-mentor initially observes an adverse event but recognizes the implications of the event and instructs the simulated colleague to implement appropriate corrective action, a negative outcome can be avoided. Through the use of Artificial Patient 406 in conjunction with the simulated colleague the trainee-as-mentor is trained and evaluated in the proficiency of their cognitive skills for treating the patient, not just their skills in performing medical procedures.

Simulation training utilizing the present invention is not simply an extension of traditional training methodology, but rather is a significant new paradigm for the medical industry. The present invention has the built-in capability to consistently train healthcare professionals in the best-demonstrated practice and in the use of the product to achieve the highest probability of producing a successful outcome. In addition, the system evaluates healthcare workers in state-of-the-art medical procedures, knowledge, cognitive skills, and documents their performance of the simulated procedures. Cognitive skills can be gained from real life experience and from good simulation experience. Real life experiences are subject to many risks as opposed to simulation experiences, which have far fewer risks.

The availability of new medical technologies is expanding at an ever-increasing rate. This expanding universe of new technologies has created a formidable task for individual physicians, nurses, and local hospitals to continuously maintain their proficiency and provide the best possible healthcare consistently across the U.S. and around the world. Recently the Institute of Medicine reported it can take seventeen years for important medical discoveries to become accepted and used by the average doctor. On an annual basis, the United States Food and Drug Administration approves approximately twenty-four new medical devices for interventional cardiology alone. The daunting problem faced by medical device manufacturers is how to effectively introduce and train 10,000 physicians at 700 key hospitals in a new product every eighteen months. The cost and throughput rate for bringing physicians to formal training centers is so high that medical device manufacturers cannot formally train all of their customers. The industry costs resulting from sub-optimal patient outcomes is estimated to be in the billions of dollars.

In the cardiovascular field alone, a one-percent reduction in the need for Cardiac Bypass Graft Surgery (“CABG”) would result in a $250 million reduction in healthcare costs to the American public. As the case experience of the physician increases, the American College of Cardiology has reported a direct correlation between the success associated with increased frequency in procedures and decreased risk of death or risk from a CABG procedure. The present invention is designed to enhance the skills of individual healthcare workers by increasing their frequency and exposure to “real patient” clinical experiences. The education and training system and method of the present invention is designed to introduce specific learning objectives and levels of complexity, or procedural consequences, into simulation courseware. Essential learning objectives can be indexed to higher levels of complexity as the trainee-as-mentor masters the new skill or product as demonstrated by resolving increasingly complex procedural consequences presented by the simulated colleague. This unique approach to training, afforded by simulation, controls the balance between overwhelming a healthcare worker with unrecoverable consequences against too little training designed to avoid poor outcomes.

As simulations are performed, metrics are gathered and stored. Metrics are pieces of raw data that indicate competency of the participant. Metrics can be time measurements, amount of substance used measurements, position and force measurements, or test scores from a didactic test. Metrics are quantified and objective, not subjective, measurements of the trainee-as-mentor's competency. Key metric parameters include basic skills, fund of knowledge, and decision making or process of care. These metrics can assist in assessing the design of new products or procedures, effectiveness of training programs, and the procedure competency of healthcare workers. As this data grows, feedback can be provided to the trainee-as-mentor. For example, a trainee-as-mentor may have missed two or three mistakes made by the simulated colleague in performing a particular simulated procedure, whereas the average trainee-as-mentor only missed one. A trainee-as-mentor can be shown where he or she falls on the curve of all previous trainee-as-mentors and immediately begin corrective measures. Databases of this metric data are extremely valuable. They are very valuable to the trainee-as-mentor because the individual will know where he or she will have to work on improving their skills. The databases are valuable because a hospital will know how well a particular individual's performance compares to others, and how well improvement is progressing where needed. The hospital will be able to assess how well their healthcare workers are doing compared to another hospital, and will be able to compare simulation results to the outcomes on actual patients. Healthcare workers can practice very difficult procedures via Simulation System 400 as well as the procedures that they may only do one or two times in a lifetime. This practice can be done ahead of time so that the healthcare worker is prepared when a real situation requiring the medical procedure with a real patient arises.

The trainee-as-mentor software and training programs, besides the real-time in-room simulations, are designed for access and review on the World Wide Web. This allows healthcare workers to access training programs tailored to their training needs around their work schedules. The present invention in conjunction with Simulation System 400 and website access provides healthcare workers with a more time-efficient and cost-effective means for maintaining their proficiency. The trainee-as-mentor medical simulation system and method of the present invention is a very efficient, effective, and consistent way to provide broad-range, on-demand simulation training and educational products. Worldwide access requires a high level of security. Proprietary courseware as well as general information may be distributed selectively. For example, a medical device manufacturer may limit distribution of new product courseware to approved clinical evaluation facilities only. Similarly, medical societies can limit distribution of new courseware to active members/subscribers.

Simulation System 400 is portable and can be moved to an appropriately sized room and is preferably set up to resemble an actual medical environment, such as a hospital emergency room, a catheter lab, operating room, etc. Lighting, sounds, medical equipment, and ancillary devices are designed to create the realism of conducting actual interventional procedures. Simulation System 400 is capable of providing individual operator as well as interactive team training. Simulation Table And Stand 402 has an upper portion which supports Artificial Patient 406 and Haptic Interface Device 404, which is located within Artificial Patient 406, at a convenient height for the team participants. In one embodiment, Artificial Patient 406 having Haptic Interface Device 404 is the SIMANTHA® Interventional Tactile-Force-Feel Simulator, an interactive artificial patient device developed by Medical Simulation Corporation. Simulation Table And Stand 402 has a lower portion with caster wheels which enable Simulation System 400 to be very portable.

Simulation System 400 as shown in FIG. 4 has two Computers 408, (the second computer is hidden from view by the first computer and is located next to it on the lower portion of Simulation Table And Stand 402). Resident on one or both of Computers 408 are the various software modules that the medical simulations are built from, including a simulation engine module, a simulated colleague module, a data manager module, a metric module, a pre-simulation brief web pages module, a testing module, a database module, and an event handler module. One skilled in the art will recognize that more or fewer computers could be utilized depending upon the computing power of the computer(s), type of simulation system (hospital emergency room, a catheterization lab, operating room, etc.) and the particular medical procedure being simulated for training purposes (crash cart, interventional cardiology, interventional radiology, interventional neurology, arthroscopy, endoscopy, laparoscopy, anesthesia, and intensive and critical care nursing). Regardless of the number, the computer(s) and other hardware devices of Simulation System 400 are interconnected over an Ethernet or other suitable Local Area Network (“LAN”) which may be, but is not limited to, wire, wireless, optical, etc.

Connected between Computers 408 and Haptic Interface Device 404 in one embodiment of the invention is Haptic Interface Computer 410. Haptic Interface Computer 410 is located out of view behind the cabinet doors in the storage area of the lower portion of Simulation Table And Stand 402.

In one embodiment Simulation System 400 incorporates six different monitors to provide visual feedback to the trainee-as-mentor and to allow user input through touch-screen capability. From Selection Monitor 412 a user may select which simulation to run and initiate the commands to begin the simulation utilizing touch-screen capability built into Selection Monitor 412, or the user may select the simulation to run utilizing Keyboard 414 and/or Mouse 416. Keyboard 414 and/or Mouse 416 rest on a slide-out tray that can be pushed back in and out of the way during the actual simulation.

Selection Monitor 412 is also used to make drug selections necessary for the simulation, which replicates the function of drug and/or fluid dispensing apparatus. The touch-screen allows for fast and direct user input, and may resemble a real drug dispenser apparatus. The drug dispenser module provides a user interface to requisition drugs and is displayed on Selection Monitor 412.

Simulated Colleague Monitor 418 displays at various times during a simulation the simulated colleague who is performing the medical procedure. However, the simulated colleague may be presented on any of the other monitors depending upon the simulation at hand. In most cases, the view presented would be of the hands of the simulated colleague so the trainee-as-mentor can observe what the simulated colleague is doing. Sometimes the view presented would be as if the trainee-as-mentor is looking over the shoulder of the simulated colleague. At other times the view presented would be from the perspective of being across the table from the simulated colleague. At other times, another animated or virtual person may be shown, such as the patient talking, a doctor, a nurse, or any other individual appropriate for a given medical simulation. The simulated colleague at the beginning of the simulation may appear on Simulated Colleague Monitor 418 and through audio output tell the trainee-as-mentor what he or she is about to do. Simulated Colleague Monitor 418 may also be touch-screen enabled. Pre-recorded messages for delivery by the simulated colleague, which may be audio only, audio and video, or video only, are stored in the database for each different medical simulation. Then, at the appropriate time, the pre-recorded audio, audio/video, or video message is called and output to the trainee-as-mentor through Simulated Colleague Monitor 418 or one of the other monitors. In a team training situation, there may be two or more trainee-as-mentor participants, each observing their own simulated colleague on one or more of the various monitors.

In another embodiment of the invention, various text files associated with the simulation selected may be retrieved from the database. The text in the files is then synthesized into audio speech, and the simulated colleague's image is synchronized with the audio speech such that the virtual simulated colleague's lips move, eyes blink, and other facial movements are coordinated such that the simulated colleague appears to be talking naturally, just as a real person would talk. Thus, three separate technologies, 3D graphics modeling and rendering, taking text and converting it into actual audio, and then combining the 3D graphics modeling with the audio, provide a very realistic virtual person. This is all done on-the-fly in response to events driven by the simulated colleague and the trainee-as-mentor during the simulation. Simulation System 400 has complex rules engine that are followed based upon the actions of the participants. The views presented of the simulated colleague that appear on Simulated Colleague Monitor 418 at various times are linked to on-the-fly events. A trainee-as-mentor participating in the simulation may give an instruction to the simulated colleague, and the simulated colleague in the simulation may take another action instead. The simulated colleague needs to say the right thing based upon these two independent decisions, and this has to be done on-the-fly. Since the trainee-as-mentor will be doing things on-the-fly, the system has to be able to respond on-the-fly as well, and will retrieve the appropriate text file for conversion to speech. In addition, some of the events are actually random, as opposed to just in response to what one of the participants did. If the trainee-as-mentor makes a bad decision then worse events may take place. Even if the trainee-as-mentor makes good decisions as far as instructing the simulated colleague, the random event could result in a bad event happening. The system does have random serious events that happen similar to occurrences in real life. Thus, the system reaches a level of realism as encountered in real life.

Road Map Monitor 420 displays stored fluoroscopic images of Artificial Patient 406 and serves as the guide to the trainee-as-mentor for the simulation procedure selected. Simulation System 400 utilizes a technique called Tri-Reality Simulation. Tri-Reality Simulation is a hybrid combination of actual (real) components, virtual components, and simulated components. A simulated component exists in reality, such as a catheter manipulated by the physician on Artificial Patient 406 in conjunction with Haptic Interface Device 404. Real components may be fluoroscopic, sonographic, MRI, PET, or like images taken from real patients and used in the simulation through display on Road Map Monitor 420. Rendered images displayed are the virtual components, such as a rendered image of a contrast injection displayed on Fluoroscopic Monitor 422.

A still picture selected by the trainee-as-mentor from one of the many diagnostic images presented to the trainee-as-mentor at the beginning of a simulation is displayed on Road Map Monitor 420 throughout the medical procedure simulation. The selection of the diagnostic image by the trainee-as-mentor is one of the factors the trainee-as-mentor is graded on during the simulation. The better or more optimal the diagnostic view the trainee-as-mentor selects, the better grade the trainee-as-mentor will receive for selecting the better road map diagnostic image. The graphics module also provides a simulation of fluoroscopic images, sonogram images, MRI, PET, or other images of the like in synchronization with the currently running simulation.

Fluoroscopic Monitor 422 shows simulated live fluoroscopic images of Artificial Patient 406 in response to the participant who is manipulating the medical device that interacts with Haptic Interface Device 404. Hemodynamic Monitor 424 displays vital statistics of Artificial Patient 406 such as blood pressure, O2 levels, pulse rate, EKG, and other related vital signs or diagnostic outputs.

In one embodiment of the invention, Road Map Monitor 420, Fluoroscopic Monitor 422, and Hemodynamic Monitor 424 are attached to a Support Bar 426. All three monitors can be raised and lowered by Support Bar 426, and can pivot about Support Bar 426 in order to provide the participants with a better view of the three monitors. In addition, all three monitors can individually be swiveled left and right, and tilted forward and back to aid in positioning each monitor to suit the preference of the participant(s).

Equipment Selection Monitor 428 allows the trainee-as-mentor to select the particular medical device, such as a catheter, that the trainee-as-mentor believes is called for in light of the particular simulation selected and the corresponding patient problem. Equipment Selection Monitor 428 typically has touch-screen capability as well. Dual Joy Stick Controller 430 simulates for the participant control of a C-Arm device and patient table panning.

As in the jet boat engine repair training scenario, the medical training scenario may begin with audio output or visual output or both, setting up the situation for the one or more trainee-as-mentor. At any time as the trainee-as-mentor observes the simulated colleague, the trainee-as-mentor may stop the simulation and provide feedback as to a mistake observed. With the sophisticated capabilities of Simulation System 400, the trainee-as-mentor may use any of the various input mechanisms, including speaking, and through voice recognition technology, interact with the simulated colleague in real time, not requiring a suspension of the flow of the training scenario, as would occur in a real live situation. As described above, the input of the trainee-as-mentor, or the lack of input through failure to observe a mistake, will affect the progress of the training scenario, and potentially cause a halt in the training scenario if too many minor errors or mistakes in succession are not detected, or a single critical error is not detected. In this instance, or at the normal conclusion of the training scenario, the training software may launch a review of the one or more trainee-as-mentor performances, indicating where mistakes were correctly observed, and those mistakes that were not caught. The training software may also generate a report of the trainee-as-mentor's performance for display on any of the monitors, or send the report to an attached or networked printer to provide the trainee-as-mentor a paper copy of his performance.

One skilled in the art will recognize that many other types of medical simulation systems could be compatible with the method and system of the present invention, and the example here given is not to be construed to be limiting to the scope of the invention. The term trainee-as-mentor or healthcare worker is broadly used to include doctors, surgeons, anesthesiologists, nurses, physician assistants, and any other type of medical position where medical simulation training would be practical.

The method and system of the present invention may also be used in the aviation field for training pilots, mechanics, air traffic control personnel, etc. The aviation field, with its outstanding safety record, has learned that to provide true cognitive training you must address four key teaching elements: manual dexterity skills, perceptual skills, fund of knowledge, and decision making. Together, these four elements are combined into a dynamic learning process that exposes the participant to a variety of situations that builds depth of experience that cannot be gained in routine practice. The commercial aviation field now relies on simulation training to the extent that commercially qualified pilots who are trained in simulators are certified to fly aircraft that are transporting revenue-paying passengers upon completion of training in certified simulation training facilities. Simulation improves decision making on the part of the participant, compared to traditional training methodology, because the consequences resulting from the interaction with the simulation interfaces are fed back to the participant immediately, just as in real life situations, forcing acceptance and/or resolution of problems in real-time. The present invention takes training to a next level. There is a tremendous difference between the ability to perform a task, and the ability to watch another perform the same task and be able to discern mistakes, miscues, poor technique, out of order steps, etc., and provide instructions on the spot to correct the mistake and prevent bad outcomes.

Trainee-as-mentor training scenarios can be incorporated into existing flight simulators, enabling a mentor as trainee pilot to observe a simulated co-pilot, or a simulated navigator. Training scenarios for air traffic controllers and airplane mechanics may be developed and run on Computer System 100 or comparable systems. One skilled in the art will recognize that the education and training system and method of the present invention is applicable to any field of endeavor where a task or procedure is amenable to simulation, and not just in the specific ex.

Having described the present invention, it will be understood by those skilled in the art that many changes in construction and widely differing embodiments and applications of the invention will suggest themselves without departing from the scope of the present invention.

While the invention has been particularly shown and described with reference to a number of embodiments, it would be understood by those skilled in the art that changes in the form and details may be made to the various embodiments disclosed herein without departing from the spirit and scope of the invention and that the various embodiments disclosed herein are not intended to act as limitations on the scope of the claims.

What is claimed is:

1. A training method comprising:
providing a simulation system for simulating a procedure, the procedure comprising one or more actions and the simulation system including a simulated colleague to perform the simulated procedure;
displaying to a trainee-as-mentor the simulated colleague performing the simulated procedure; and
accepting input to the simulation system from the trainee-as-mentor in response to the performance of the simulated procedure by the simulated colleague.

2. The training method of claim 1 further comprising simulating an error associated with the colleague's simulated performance of an action.

3. The training method of claim 2 further comprising analyzing any input to the simulation system from the trainee-as-mentor received within a select time after the error to determine at least one of the following:
(a) whether the trainee-as-mentor recognized the error; and
(b) whether any input from the trainee-as-mentor is appropriate to mitigate a possible effect of the error.

4. The training method of claim 3 further comprising simulating the performance of a subsequent action by the simulated colleague wherein the subsequent action is selected from a group of multiple possible subsequent actions, and the selection is based upon the analysis of the trainee-as-mentor's input or non-input received within a select time after the error.

5. The training method of claim 3 further comprising simulating an undesirable occurrence upon determination that the trainee-as-mentor did not provide input appropriate to mitigate a possible effect of the error.

6. The training method of claim 5 wherein the undesirable occurrence is the erroneous performance of a subsequent action by the simulated colleague which compounds the first error.

7. The training method of claim 5 wherein the undesirable occurrence is the failure of the simulated colleague to successfully complete the simulated procedure.

8. The training method of claim 3 further comprising simulating a desirable occurrence upon determination that the trainee-as-mentor did provide input appropriate to mitigate a possible effect of the error.

9. The training method of claim 3 further comprising:
pausing the performance of the simulated procedure upon receipt of input from the trainee-as-mentor to the simulation system; and
providing feedback to the trainee-as-mentor regarding the error or the trainee-as-mentor's response to the error.

10. The training method of claim 1 further comprising pausing the performance of the simulated procedure to accept input to the simulation system from the trainee-as-mentor.

11. The training method of claim 1 further comprising continuing the performance of the simulated procedure at a realistic time rate while accepting input to the simulation system from the trainee-as-mentor.

12. The training method of claim 1 wherein the input to the simulation system from the trainee-as-mentor is delivered through at least one of a keyboard, a keypad, a computer mouse, a touch screen, a microphone, a joystick, a mechanical device in communication with the simulation system, a writing tool in communication with the simulation system, a simulated tool and a detector associated with the trainee-as-mentor.

13. The training method of claim 1 wherein the simulated procedure is displayed to the trainee-as-mentor as at least one of an image, audible sound, tactile feedback and text.

14. The training method of claim 13 wherein the simulated procedure is displayed to the trainee-as-mentor visually through at least one of multiple selectable points of view.

15. The training method of claim 2 further comprising generating a report upon the completion of the simulated procedure containing commentary upon any error and the trainee-as-mentor's response thereto.

16. A simulation system for training comprising:
means for simulating the performance of a procedure by a simulated colleague;
means for displaying to a trainee-as-mentor the simulated colleague performing the simulated procedure; and
means for accepting input to the simulation system from the trainee-as-mentor in response to the performance of the simulated procedure by the simulated colleague.

17. The simulation system of claim 16 further comprising means for simulating an error associated with the colleague's simulated performance of an action.

18. The simulation system of claim 17 further comprising means for analyzing any input to the simulation system from the trainee-as-mentor received within a select time after the error to determine at least one of the following:
(a) whether the trainee-as-mentor recognized the error; and
(b) whether any input from the trainee-as-mentor is appropriate to mitigate a possible effect of the error.

19. The simulation system of claim 18 further comprising means for simulating the performance of a subsequent action by the simulated colleague wherein the subsequent action is selected from a group of multiple possible subsequent actions, and the selection is based upon the analysis of the trainee-as-mentor's input or non-input received within a select time after the error.

20. The simulation system of claim 18 further comprising means for simulating an undesirable occurrence upon determination that the trainee-as-mentor did not provide input appropriate to mitigate a possible effect of the error.

21. The simulation system of claim 20 wherein the undesirable occurrence is the erroneous performance of a subsequent action by the simulated colleague which compounds the first error.

22. The simulation system of claim 20 wherein the undesirable occurrence is the failure of the simulated colleague to successfully complete the simulated procedure.

23. The simulation system of claim 18 further comprising means for simulating a desirable occurrence upon determination that the trainee-as-mentor did provide input appropriate to mitigate a possible effect of the error.

24. The simulation system of claim 18 further comprising:
means for pausing the performance of the simulated procedure upon receipt of input from the trainee-as-mentor to the simulation system; and
means for providing feedback to the trainee-as-mentor regarding the error or the trainee-as-mentor's response to the error.

25. The simulation system of claim 16 further comprising means for pausing the performance of the simulated procedure to accept input to the simulation system from the trainee-as-mentor.

26. The simulation system of claim 16 further comprising means for continuing the performance of the simulated procedure at a realistic time rate while accepting input to the simulation system from the trainee-as-mentor.

27. The simulation system of claim 16 wherein the input to the simulation system from the trainee-as-mentor is delivered through at least one of a keyboard, a keypad, a computer mouse, a touch screen, a microphone, a joystick, a mechanical device in communication with the simulation system, a writing tool in communication with the simulation system, a simulated tool and a detector associated with the trainee-as-mentor.

28. The simulation system of claim 16 wherein the simulated procedure is displayed to the trainee-as-mentor as at least one of an image, audible sound, tactile feedback and text.

29. The simulation system of claim 28 wherein the simulated procedure is displayed to the trainee-as-mentor visually through at least one of multiple selectable points of view.

30. The simulation system of claim 17 further comprising means for generating a report upon the completion of the simulated procedure containing commentary upon any error and the trainee-as-mentor's response thereto.

31. A computer readable medium having computer-executable instructions for performing a training method comprising:
simulating a procedure, the procedure comprising one or more actions
simulating a colleague to perform the simulated procedure;
displaying to a trainee-as-mentor the simulated colleague performing the simulated procedure; and
accepting input to the simulation system from the trainee-as-mentor in response to the performance of the simulated procedure by the simulated colleague.

32. The training method of claim 1 further comprising computer-executable instructions for simulating an error associated with the colleague's simulated performance of an action.

33. The computer readable medium having computer-executable instructions for performing the training method of claim 32 further comprising computer-executable instructions for analyzing any input to the simulation system from the trainee-as-mentor received within a select time after the error to determine at least one of the following:
(a) whether the trainee-as-mentor recognized the error; and
(b) whether any input from the trainee-as-mentor is appropriate to mitigate a possible effect of the error.

34. The computer readable medium having computer-executable instructions for performing the training method of claim 33 further comprising computer-executable instructions for simulating the performance of a subsequent action by the simulated colleague wherein the subsequent action is selected from a group of multiple possible subsequent actions, and the selection is based upon the analysis of the trainee-as-mentor's input or non-input received within a select time after the error.

35. The computer readable medium having computer-executable instructions for performing the training method of claim 33 further comprising computer-executable instructions for simulating an undesirable occurrence upon determination that the trainee-as-mentor did not provide input appropriate to mitigate a possible effect of the error.

36. The computer readable medium having computer-executable instructions for performing the training method of claim 35 wherein the undesirable occurrence is the erroneous performance of a subsequent action by the simulated colleague which compounds the first error.

37. The computer readable medium having computer-executable instructions for performing the training method of claim 35 wherein the undesirable occurrence is the failure of the simulated colleague to successfully complete the simulated procedure.

38. The computer readable medium having computer-executable instructions for performing the training method of claim 33 further comprising computer-executable instructions for simulating a desirable occurrence upon determination that the trainee-as-mentor did provide input appropriate to mitigate a possible effect of the error.

39. The computer readable medium having computer-executable instructions for performing the training method of claim 33 further comprising computer-executable instructions for:
pausing the performance of the simulated procedure upon receipt of input from the trainee-as-mentor to the simulation system; and
providing feedback to the trainee-as-mentor regarding the error or the trainee-as-mentor's response to the error.

40. The computer readable medium having computer-executable instructions for performing the training method of claim 31 further comprising computer-executable instructions for pausing the performance of the simulated procedure to accept input to the simulation system from the trainee-as-mentor.

41. The computer readable medium having computer-executable instructions for performing the training method of claim 31 further comprising computer-executable instructions for continuing the performance of the simulated procedure at a realistic time rate while accepting input to the simulation system from the trainee-as-mentor.

42. The computer readable medium having computer-executable instructions for performing the training method of claim 31 wherein the input to the simulation system from the trainee-as-mentor is delivered through at least one of a keyboard, a keypad, a computer mouse, a touch screen, a microphone, a joystick, a mechanical device in communication with the simulation system, a writing tool in communication with the simulation system, a simulated tool and a detector associated with the trainee-as-mentor.

43. The computer readable medium having computer-executable instructions for performing the training method of claim 31 wherein the simulated procedure is displayed to the trainee-as-mentor as at least one of an image, audible sound, tactile feedback and text.

44. The computer readable medium having computer-executable instructions for performing the training method of claim 43 wherein the simulated procedure is displayed to the trainee-as-mentor visually through at least one of multiple selectable points of view.

45. The computer readable medium having computer-executable instructions for performing the training method of claim 32 further comprising computer-executable instructions for generating a report upon the completion of the simulated procedure containing commentary upon any error and the trainee-as-mentor's response thereto.
